(19) United States
(12) Patent Application Publication
(10) Pub. No.: US 2015/0056971 A1
(43) Pub. Date: Feb. 26, 2015

(54) CREATING MULTIPLE HOME PHONE GROUPS FROM A NETWORK OF COMMUNICATION DEVICES

(71) Applicant: International Business Machines Corporation, Armonk, NY (US)

(72) Inventors: David B. Lection, Research Triangle Park, NC (US); Ruthie D. Lyle, Research Triangle Park, NC (US); Eric L. Masselle, Research Triangle Park, NC (US)

(73) Assignee: International Business Machines Corporation, Armonk, NY (US)

(21) Appl. No.: 14/220,031

(22) Filed: Mar. 19, 2014

Related U.S. Application Data
(63) Continuation of application No. 14/010,217, filed on Aug. 26, 2013.

(51) Int. Cl. H04W 4/02; H04B 7/185; H04M 3/56; H04W 68/00; H04W 40/02

(52) U.S. Cl. CPC H04W 4/023; H04W 68/005; H04W 40/023; H04M 3/563; H04B 7/18567
USPC 455/416; 455/414.1

(57) ABSTRACT

Exemplary embodiments for creating one or more home phone groups from a network of communication devices comprise receiving from one or more users, configuration parameters for the one or more home phone groups that identify the communication devices in the home phone groups; a proximity designation for each of the communication devices; and a group mode setting for each of the communication devices that controls participation in the assigned home phone groups. The group mode setting for each of the communication devices is automatically activated is when the current location of each respective communication device meets the proximity designation. Users control participation of their communication devices within the assigned home phone groups by changing the designated proximity and/or a manual override of the group mode setting. When an incoming call is received, the call is routed to each communication device in the identified home phone group that has an active group mode setting.

### CROSS-REFERENCE TO RELATED APPLICATIONS

This application is a Continuation of U.S. patent application Ser. No. 14/010,217, filed Aug. 26, 2013, and is assigned to the assignee of the present application and incorporated herein by reference.

### BACKGROUND

Increasingly, consumers are foregoing a land line based home phone in favor of individual cell phones. However, there are some advantages to a home phone with multiple satellite receivers, rather than just a collection of individual cell phones.

Accordingly, it would be desirable to emerge aspects of both the cell phone and home phone solutions.

### BRIEF SUMMARY

Exemplary embodiments for creating one or more home phone groups from a network of communication devices comprise receiving from one or more users, configuration parameters for the one or more home phone groups that identify the communication devices in the home phone groups; a proximity designation for each of the communication devices; and a group mode setting for each of the communication devices that controls participation in the assigned home phone groups. The group mode setting for each of the communication devices is automatically activated is when the current location of each respective cell phone meets the proximity designation. Users control participation of their communication devices within the assigned home phone groups by changing the designated proximity and/or a manual override of the group mode setting. When an incoming call is received, the call is routed to each communication devices in the identified home phone group that has an active group mode setting.

### BRIEF DESCRIPTION OF SEVERAL VIEWS OF THE DRAWINGS

FIG. 1 is a diagram illustrating one embodiment of a system for providing multiple home phone groups from a network of communication devices.

FIG. 2 is a flow diagram illustrating one embodiment of a process for creating multiple home phone groups from a network of communication devices.

FIG. 3 is a diagram illustrating an example configuration of home phone groups and call routing based on the configuration.

FIG. 4 is block diagram illustrating the routing of received calls for home phone groups in further detail.

### DETAILED DESCRIPTION

The exemplary embodiment relates to creating multiple home phone groups from a network of communication devices. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for creating one or more home phone groups from a network of communication devices. An application executing on a communication service provider server (and optionally an app on the cell phones) enables users of cell phones to define dynamic home phone groups of communication devices based on a designated proximity to a location or to other communication devices in a group to alter the behavior of the communication devices in each group, where a group is a set of communication devices that could possibly be on a ring list. Communication devices that are detected within the designated proximity are automatically placed in home phone group mode to form a home phone group or network of communication devices. Each communication device can be assigned to multiple home phone groups, and each communication device can then act as a receiver for all calls on all phones in the assigned home phone groups, and display the identity of the intended recipient of the call, and/or provide a unique ring for each cell phone number. According to another aspect of the exemplary embodiment, the user of each communication device can manually choose whether to have the communication device participate in the home phone groups to which it is assigned, such that each communication device determines its own state with respect to all home phone groups to which it may belong. Users also have the option to set up a home phone group where the only means of activating group mode is a manual one with no automated activation based on location. In a further embodiment each of the home phone groups a be assigned its own home phone number(s). The assigned home phone number may be the number most often called when attempting to reach members of the “household” (i.e., the true equivalent of a home phone).

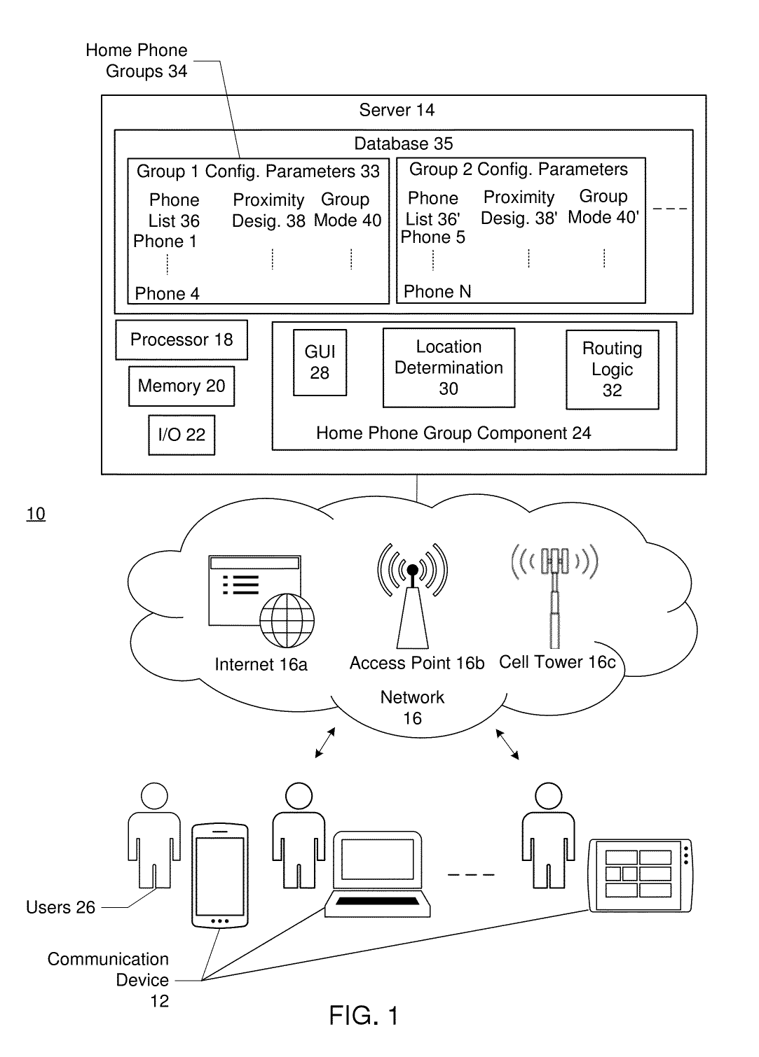

FIG. 1 is a diagram illustrating one embodiment of a system for providing multiple home phone groups from a network of communication devices. The home phone group system 10 may comprise a plurality of communication devices 12 that communicate with a server 14 over a network 16.

In an exemplary embodiment, the communication devices 12 comprise devices such as cell phones, tablets, notebooks, watches, televisions, set-top boxes, and gaming systems, that can communicate with the server and each other via cell or WiFi/WiMax/VoIP based on what is available and have the capability of being addressed via a phone number (e.g., a tablet running Skype™).

The network 16 may comprise any combination of a public network, such as the Internet 16a, an access point 16b for a wireless network (e.g., a WLAN, or a WMAX), and a cell tower network 16c. In one embodiment, the server 14 may be controlled by a communication service provider (e.g., cell phone provider or VIOP service). The server 14 may represent a single server or multiple servers, each having at least a processor 18, a memory 20, and an input/output (I/O) 22 coupled together via a system bus (not shown). In one embodiment, the server 14 may comprise a Web server, while in another embodiment the server 14 may comprise an application server.

In one embodiment, the server 14 executes a home phone group component 24, which may include a GUI 28, a location determination component 30 and a routing logic component 32. The GUI 28 of the home phone group component 24 enables the users 26 to enter configuration parameters 33 to set up home phone groups 34 of communication devices 12 based on proximity. In one embodiment, the GUI 28 allows user to enter the configuration parameters 33 either through a web browser over the Internet 16a and/or through an optional application (not shown) running on the communication devices 12. In one embodiment, the configuration parameters 33 may be stored in a database 35 (which may be local or remote to the server 14).

According to one aspect of the exemplary embodiment, each home phone group 34 may include a phone list 36, a proximity designation 38 and a group mode setting 40. The phone list 36 is a list of communication devices 12 that are assigned to the home phone group 34. The proximity designation 38 defines a geographic location or a distance from one another. In one embodiment, the proximity designation 38 may be assigned globally to communication devices 12 in the phone list 36. However, in a further embodiment, the proximity designation 30 assigned to each communication device 12 may be modified or overridden by the user of the communication device 12. The group mode setting 40 determines each communication device's participation to the home phone group 34. The group mode setting 40 is provided to each communication device 12 on the list and is set automatically by the home phone group component 24, but may also be overridden by the user of the communication device 12 or defined with a manual-only group mode activation, i.e., each user simply declares they are “home” by setting their group mode setting to ON. Further, it should be noted that an embodiment can also include the ability for the user to manually activate group mode even for home phone groups where proximity is used to automatically activate the group mode. For instance, if a user is expecting a call to their home phone number assigned to a home phone group, but is stuck in traffic; rather than miss the call, the user can activate group mode for that home phone group while still in the car, even though he and his phone are outside the proximity setting defined for that home phone group.

During operation, the location determination component 30 periodically determines the location of each of the communication devices in the home phone groups 34 and compares the location to the proximity designation 38 associated with the communication device. If the location of a particular communication device is within the proximity designation 38, the home phone group component 24 automatically activates or turns-on the group mode setting 40 associated with the communication device. Conversely, if the location of the particular communication device falls outside of the proximity designation 38, the home phone group component 24 automatically deactivates or turns-off the group mode setting 40.

However, even if the group mode setting 40 is automatically activated for a particular phone, the user of the phone may manually turn-off the group mode setting 40, either using a web browser, or via the app on the communication device. This enables each communication device/user to determine the communication device's state with respect to all home phone groups to which the communication device is assigned.

When a call is received for the home phone group, i.e., the home phone number assigned to the group, or any of the active communication devices in a home phone group 34, the routing logic 32 automatically routes the call and rings all the active communication devices in the home phone group 34. Consequently, each communication device can serve as a receiver for all calls on all communication devices to the home phone groups to which the communication device is assigned in one embodiment, when a call is routed to one or more communication devices in a home phone group, each of the ringing communication devices may display the identity of the intended recipient of the call, and/or provide a unique ring for each communication device number.

In a further embodiment, each of the users 26 may change the proximity designation 38 assigned to their communication device. For example, assume a father creates a home phone group that establishes a virtual home network at a vacation rental on a beach for several family members and friends. The father logs into the home phone group component 24, names the home phone group “beach”, lists the communication devices in the home phone group, and sets the location of the rental house as the proximity designation. When the location determination component 30 detects the listed communication devices arriving within the proximity of the location of the rental house, the group mode for each of the communication devices is turned-on. When any of the communication devices receives a call, each of the communication devices in the group will ring, allowing the call to be answered using any of the communication devices lying around the beach house.

Now assume that a second user having a communication device defined for this home phone group won't be able to join the first person at the beach until the next day. However, according to the exemplary embodiment, the second person can log into the home phone group component 24 and set their own home location as the proximity designation 38 as a trigger for turning-on the beach group mode setting, so that the calls to the communication devices of any group member, including the second person, will behave as if they are both at a single location.

Both the server 14 and the communication devices 12 may include components of typical computing devices, such as one or more processors 18, input devices (e.g., keyboard, pointing device, microphone for voice commands, buttons, touch screen, etc.), output devices (e.g., a display device). The server 14 and the communication devices 12 may further include computer-readable media, e.g., memory 20 and storage devices (e.g., flash memory, hard drive, optical disk drive, magnetic disk drive, and the like) containing computer instructions that implement an embodiment of a process that enables creation of multiple home phone groups from a network of communication devices.

The processor 18 may be part of data processing system suitable for storing and/or executing software code including an operating system and various web applications 16. The processor 18 may be coupled directly or indirectly to elements of the memory 20 through a system bus (not shown). The memory 20 can include any combination of local memory employed during actual execution of the program code, bulk storage, and cache memories which provide temporary storage of at least some program code in order to reduce the number of times code must be retrieved from bulk storage during execution.

Input/output or I/O devices 22 (including but not limited to keyboards, displays, pointing devices, etc.) can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

Although the server 14 is shown as a single computer, it should be understood that the functions of server 14 may be distributed over more than one server, and the functionality of software components may be implemented using a different number of software components. For example, the home phone group component may be implemented as more than one component.

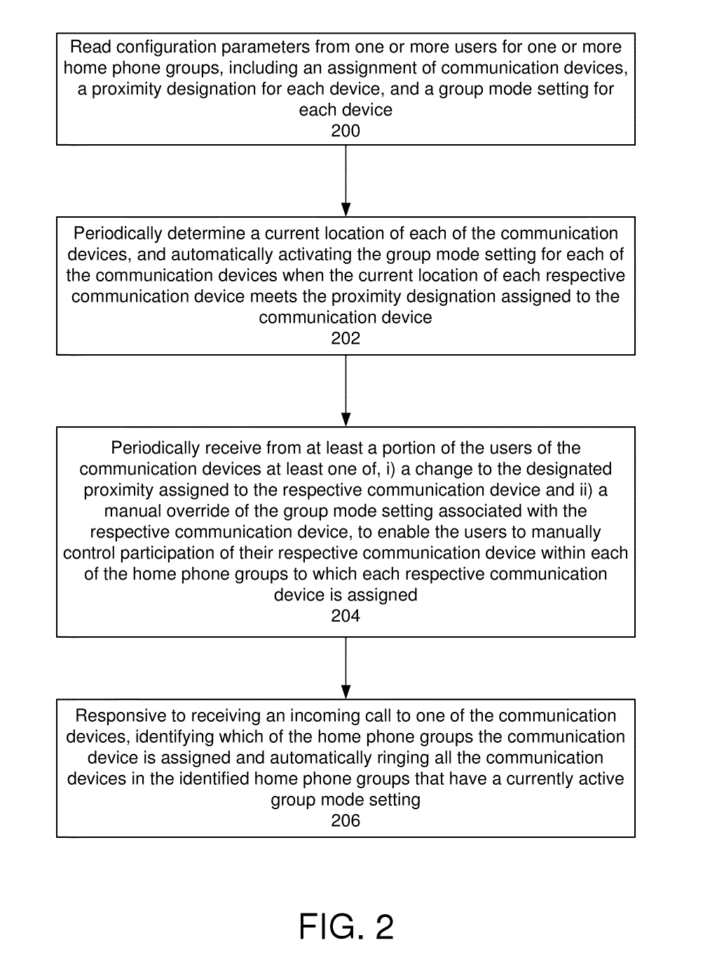

FIG. 2 is a flow diagram illustrating one embodiment of a process for creating multiple home phone groups from a network of communication devices. In one embodiment, the method may be performed by at least the home phone group component 24 executing on at least one processor.

In one embodiment, the process may begin by reading configuration parameters 33 from one or more users for one or more home phone groups (block 200). The configuration parameters 33 for each of the home phone groups may include: an assignment of communication devices to the home phone group (e.g., phone list 36), where each of the communication devices are identified by at least a corresponding phone number (in one embodiment, at least a portion of communication devices may be assigned to more than one of the home phone groups); the proximity designation 38 for each of the communication devices assigned to the home phone group that defines a proximity to a designated geographic location (e.g., a geo-fence) or a proximity to one or more other phones; and the group mode setting 40 for each of the communication devices assigned to the home phone group that dynamically controls participation of the corresponding communication device in the assigned home phone group. According to one aspect of the exemplary embodiment, the group mode setting 40 for particular communication device is automatically set by the home phone group component 24, but may also be manually overridden by a user of the communication device.

The proximity designation 38 established for a home phone group can be varied according to user options and/or the accuracy and granularity of the GPS units in the communication devices. In the case of user options, a home phone group can be set up to operate in an area that extends beyond the boundary of the home, to include, for instance, the yard, or even one or more adjacent houses, to provide the home mode behavior while working in the garden, or visiting next door. The home phone group could also be made to operate for a completely different location, for instance, a condo a user has rented for his family vacation could be established as the family's current home for the purposes of the home phone group.

In a further embodiment, the configuration parameters may also include one or more optional home phone numbers that may be assigned to the home phone group.

In one embodiment, one user may log into the home phone group component 24 to create the home phone group 34 and provide the configuration parameters, including the phone list 36 of communication devices defining the home phone group and the proximity designation 38. In an alternative embodiment, the configuration parameters are entered by each user of each communication device assigned to the home phone groups after the home phone group is initially created. That is, the users must register their own devices with the home phone group component 24, perhaps after receiving an email or text prompting them to do so. After the home phone group is setup, each user is are free to manually change the proximity designation 38 and group mode 40 associated with the user's communication device. Once the configuration parameters are saved, the home phone group component 24 periodically reads the parameters to check the status of the parameters, such as determining a phone's compliance of the proximity designation and so on.

In a further embodiment, if the accuracy is sufficient, a device's behavior could be scoped to an individual room or rooms. For instance, a household could have a set of generic cell phones set up to behave differently, depending upon location. If the son is home, picks up one of the phones, and goes to his room, the phone will now act as his phone. The son's phone now takes on the behavior, set up, features, etc. of the son's phone, as the location dictates the setup of the phone and its presumed owner, not the device itself. If desired, the phones could be configured to require input of a code when the location dictates; for instance, if the son picks up any of the generic phones available in the home and goes to his room, he may be prompted for an input code in order for the phone to behave as if it were the son's phone.

Referring still to FIG. 2, the home phone group component 24 periodically determines a current location of each of the communication devices, and automatically activates the group mode setting 40 for each of the communication devices when the current location of each respective communication device meets the proximity designation 38 assigned to the communication device (block 202).

In one embodiment, the location determination component 30 determines the current location of each of the communication devices using a variety of mechanisms. For example, the location determination component 30 may determine the current location of the cell based on GPS (global positioning system) tracking, cell tower 16c triangulation, use of network access points 16b used by the communication devices, and an Internet protocol (IP) address of an account associated with the users or the communication devices.

When the current location of a communication device is received, the location determination component 30 determines whether or not the group mode setting for the phone needs to be toggled based on the current location. If for example, the current location of the communication device is outside the proximity designation 38, the location determination component 30 automatically deactivates or turns-off the group mode setting for the communication device and vice versa.

The home phone group component 24 periodically receives from at least a portion the users of the communication devices at least one of, i) a change to the designated proximity assigned to the respective communication device and ii) a manual override of the group mode setting associated with the respective communication device, to enable the users to manually control participation of their respective communication device within each of the home phone groups to which each respective communication device is assigned (block 204).

Responsive to receiving an incoming call to one of the communication devices, the home phone group component 24 identifies which of the home phone groups the communication device is assigned and automatically rings all the communication devices in the identified home phone groups that have a currently active group mode setting (block 206). In the embodiment where a home phone group number assigned to a particular home group is received by the home phone group component 24, the home phone group component 24 also rings all the active communication devices in that home phone group.

According to the exemplary embodiments, a user-defined network of communication devices is provided where the set of communication devices participating in each home phone group is both self-determining and dynamic based on each communication device in each home phone group having its own proximity designation as well as a group mode setting that can be manually controlled by the user. And because a particular communication device may belong to many home phone groups and a call to any active member of a home phone groups rings all other active members, the home phone group system provides a process for mapping many communication device numbers to many communication devices.

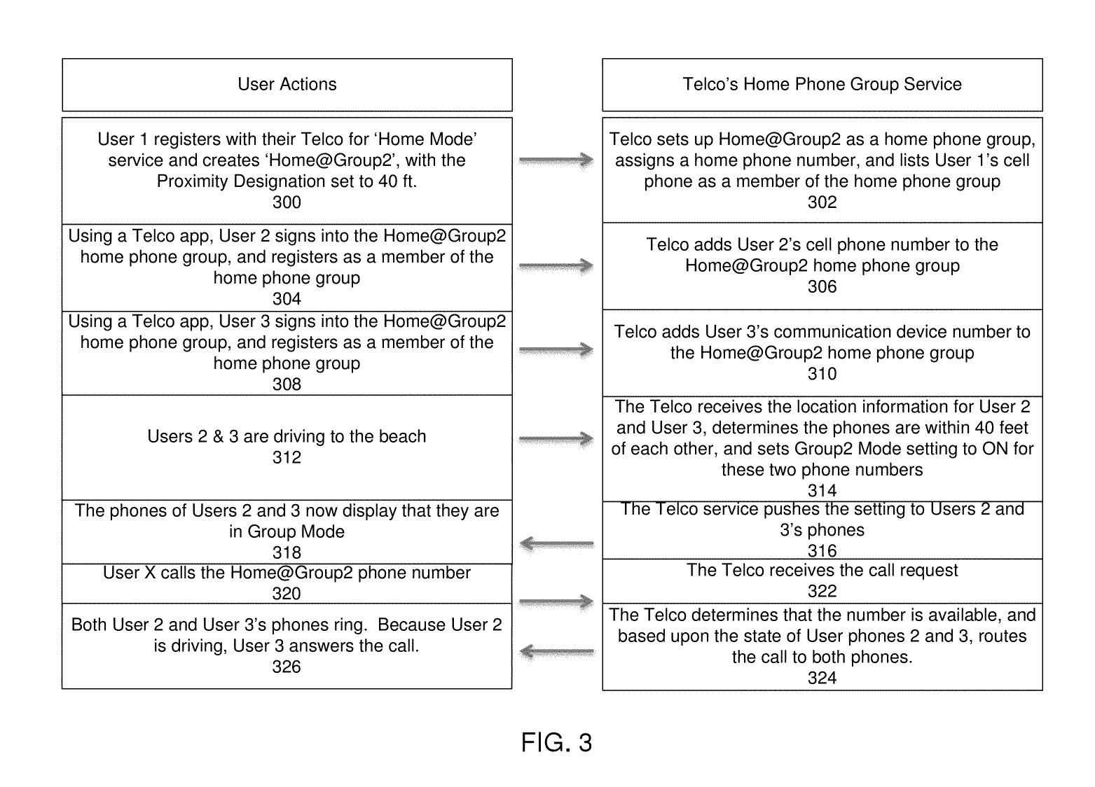

FIG. 3 is a diagram illustrating an example configuration of home phone groups and call routing based on the configuration in one embodiment. User actions are shown in the left-hand column and actions performed by a telephone company's (telco) home phone group service are shown in the right-hand column.

In block 300, user 1 registers with the telco's home phone group service and creates a home phone group called home@group1 and sets a proximity designation to within 40 feet of other phones in the home phone group. In block 302 the telco service sets up the home@group1 as a home phone group, assigns a home phone number to the home phone group, and lists user 1's cell phone as a member of the home phone group.

In block 304, using a telco app (on phone or web), user 2 signs into the home@group1 home phone group and registers as a member of the home phone group. In block 306, the telco service as user 2's cell phone number to the home@group1 home phone group. If user 2 does not define a proximity designation for his/her cell phone, the proximity designation created for the home phone group may be used by default.

In block 308, using a telco app, user 3 signs into the home@group1 home phone group and registers as a member of the home phone group. In block 310, the telco service adds user 3's cell phone number to the home@group1 home phone group.

In block 312, users 2 and 3 are driving to the beach. In block 314, the telco service receives the location information for user 2 and user 3, determines the phones are within 40 feet of each other and turns-on the group1 mode setting for these two phone numbers. In block 316, the telco service pushes the setting to users 2 and 3's cell phones. In block 318, the cell phones of users 2 and 3 display that they are in group mode.

In block 320, user X calls the home phone number assigned to the home@group1. In block 322 the telco service receives the call request. In block 324 the telco service determines that the number is available and based upon the state of the group mode setting (ON) of user phones 2 and 3, routes the call to both cell phones. In block 326 both cell phones of user 2 and 3 ring. Because user 2 is driving, user 3 answers the call.

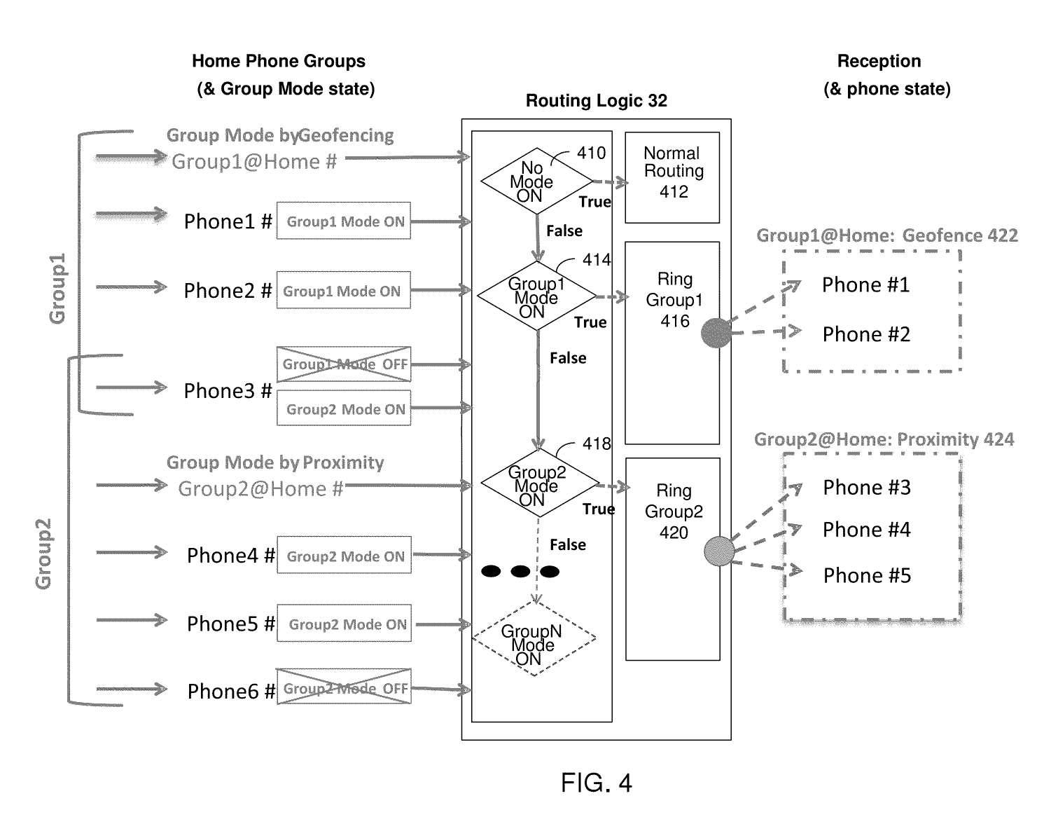

FIG. 4 is block diagram illustrating the routing of received calls for home phone groups in further detail. The left-hand column shows configured home phone groups. The middle column shows the processing of received phone calls by the routing logic 32 of the home phone group component 24. And the right-hand column shows call reception.

In this example, the configuration for two home phone groups, group1 and group2, is shown. Phones 1-3 are assigned to group1 and phones 3-6 are assigned to group2. A group1@home phone number has been assigned to group1, and the group1 mode setting for each group1 phone is controlled by geo-fence location. A group2@home phone number has been assigned to group2, and the group2 mode setting for each group2 phone is controlled by proximity to other phones in group2.

According to one aspect of exemplary embodiment, phone 3 belongs to two groups—group1 and group2, and based on the context of the phone's group1 mode setting and the group 2 mode setting, phone 3 may dynamically participate in either or both group1 and group2.

When the routing logic 32 receives a phone call, the routing logic 32 looks up which home phone group(s) the called number is assigned, determines the state of the group mode setting for each of the cell phones in the assigned home phone group(s), and routes the call to the cell phones in the home phone group(s) depending on the current context of each phone's group mode setting, as follows.

As a first example, assume a call is received for phone 6. The routing logic 32 first determines if there is no group mode setting is ON for that phone (block 410). This is true for phone 6 as the group2 mode setting is OFF for phone 6. Since phone 6 is not participating in group mode, the routing logic 32 performs normal routing (block 412) and rings phone 6.

As a second example, assume a call is received for any cell phone assigned to group1 or for the group1@home phone number. In this case, the routing logic 32 determines that the no mode ON determination (block 410) is false. It is then determined that there are group1 mode settings ON for phones in group1 (block 414). Phones 1 and 2 are within the geo-fence location 422 set up for group1, and have corresponding group1 mode settings ON. Phone 3 is either outside the geo-fence location 422 and/or the user has manually turned-off the group1 mode setting. Therefore, the routing logic routes the call to phones 1 and 2.

As a third example, assume a call is received for any cell phone assigned to group2 or for the group2@home phone number. In this case, the routing logic 32 determines that the no mode ON determination (block 410) is false, as is the group1 mode ON determination (block 414). It is then determined that there are group2 mode settings ON for phones in group2 (block 418). Phones 3-5 are within the proximity 424 of one another as set up for group2, and have corresponding group2 mode settings ON. Phone 6 is either outside the proximity 424 or the user has manually turned-off the group2 mode setting. Therefore, the routing logic routes the call to phones 3, 4 and 5.

As the foregoing illustrates, cell phones within a designated proximity and that are in a group mode form a home phone group of cell phones where cell phone in the home mode network can act as a receiver for all calls on all cell phones in the home phone group.

According to a further aspect of exemplary embodiment, the home phone group may be configured with options for call handling after the call is picked up by one of the cell phones in the home phone group.

For example, assume a husband and wife are at home where a home phone group has been set up. When someone calls the wife's cell phone, both husband and wife's cell phones ring, using her ringtone and a display that indicates the call is for her. The call can be answered using either the cell phones. In the scenario where the wife answers on the husband's cell phone, the remaining phone (hers) is available for other incoming or outgoing calls. Alternatively, according to another aspect of exemplary embodiment, the home phone group system 10 provides an option on the wife's phone that enables the husband to pick up her phone and choose to join his wife on her current call. If there is a subsequent call for the wife while she's still on the current call (using the husband's phone), the system 10 may route that call to the husband's phone, since that is where the last call for the same number was answered (i.e., that's the phone my wife is currently using). If the husband receives a call while she is still using his phone, the system 10 may ring her phone so the husband can answer the call there.

The system 10 may also provide each cell phone with an option to transfer a call to the cell phone that owns the phone number for the call. For instance, in the scenario above, the wife can transfer her current call, which she answered on her husband's phone, to her cell phone, and then continue her conversation as she gets into her car and drives away, severing her from home group mode. This allows her to leave with her own phone.

A home group or home mode network of cell phones can operate along with a standard (land line) home phone, to extend the abilities and reach of that standard home phone, or it can operate without the presence of any standard home phone. In the second case, when no cell phones are present in the home, there is no home phone, and no calls are received there. Further, the home group itself could have its own phone number, even without the presence of a standard home phone. In this case, when any of the set of cell phones capable of participating in the home phone group are home, if the home phone group number is called, the cell phones may respond similarly to a set of satellite phones for a standard home phone (even though there is none), but could otherwise retain their individual cell phone behavior when one of the cell phone numbers is called. In this configuration, where no standard home phone exists, but a home phone number exists, calls made to the home phone number when no cell phones are within the home can—if desired—be routed to one or more of the cell phones that participate in the home phone network, regardless of their location, or routed to an answering service where callers can leave a message.

The capabilities described above afford additional features that provide flexibility in managing a work/life balance. The home phone groups' phone number could be configured to identify incoming calls based upon a list of phone numbers, and pass certain calls through to an answering service where the caller can leave a message. A user might put all numbers related to work and clients on such a list, and set the filter to operate between 8 pm and 8 am, to prevent work calls from interrupting the user's off-work hours. For instance, in an embodiment where no home based phone exists (only the network of location-based cell phones), if the filter is set as described above, a call from a client to either the user's cell phone number or home number may be routed to the answering service. In one embodiment, the home phone group could actually have multiple numbers, so that a ‘special’ home number could be provided to a select few clients, for instance.

In a further aspect of the exemplary embodiments, the home phone group system may be configured to also route Short Message Service (SMS) messages similar to incoming cell phone calls. SMS messaging usage is extremely popular and in hyper usage worldwide. SMS messages are addressed by the recipient's telephone number in the same way a phone call is addressed by the telephone number. While phone calls may be propagated to multiple family members, in most cases SMS messages are intended for a specific person, and for that reason should be subject to delivery rules that guarantee the message be delivered to the specific person. The exemplary embodiments may establish the following routing rules for SMS messages via the configuration parameters:
1. If SMS message routing is set to be delivered to the same communication device as a corresponding communication device call, and the communication device is owned by the intended message recipient, the message is delivered normally to that communication device.
2. If the SMS message routing is set to be delivered to the same communication device as a corresponding phone call, and the communication device is NOT owned by the intended message recipient, the message is delivered in an “opaque” container that requires the user to enter a passcode to unlock the message. In this manner only the intended recipient will see the message, if it is routed to a different communication device, than their owning communication device.
3. If the SMS message routing is set to be delivered to the home phone group telephone number, the message is delivered to all communication devices having active group mode settings, or optionally, to all communication devices in the home phone group regardless of group mode setting.

A method and system for creating one or more home phone groups from a network of communication devices has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for creating one or more home phone groups from a network of communication devices, the method performed by at least one software component executing on at least one processor, the method comprising:
reading configuration parameters from one or more users for the one or more home phone groups, wherein the configuration parameters for each of the one or more home phone groups include:
an assignment of communication devices to the home phone group, wherein each of the communication devices are identified by at least a corresponding phone number;
a proximity designation for each of the communication devices assigned to the home phone group that defines a proximity to a designated geographic location or to one or more other phones; and
a group mode setting for each of the communication devices assigned to the home phone group that dynamically controls participation of the corresponding communication device in the assigned home phone group;
periodically determining a current location of each of the communication devices, and automatically activating the group mode setting for each of the communication devices when the current location of each respective communication device meets the proximity designation assigned to the communication device;
periodically receiving from at least a portion of the users of the communication devices, at least one of i) a change to the designated proximity assigned to the respective communication device and ii) a manual override of the group mode setting associated with the respective communication device, to enable the users to manually control participation of their respective communication device within the one or more home phone group to which each respective communication device is assigned; and
responsive to receiving an incoming call to one of the communication devices, identifying which of the one or more home phone groups the communication device is assigned and automatically ringing all the communication devices on the identified home phone groups that have a currently active group mode setting.

2. The method of claim 1, wherein the configuration parameters further comprise a home phone number assigned to a first home phone group.

3. The method of claim 2, further comprising; responsive to receiving a call to the home phone group number, ringing all the communication devices in the first home phone group having a currently active group mode setting.

4. The method of claim 1, wherein the configuration parameters are received from by one user.

5. The method of claim 1, wherein the configuration parameters are received from each user of each communication device assigned to the home phone groups.

6. The method of claim 1, wherein periodically determining the current location of each of the communication devices comprises at least one of: GPS tracking, cell tower triangulation, use of network access points, and use of an IP address of an account associated with the users or the communication devices.

7. The method of claim 1, wherein periodically determining the current location of each of the communication devices further comprises: automatically deactivating the group mode setting for each of the communication devices when the current location of each respective communication device is outside the proximity designation assigned to the communication device.

8. The method of claim 1, wherein automatically ringing all the communication devices on the identified home phone groups that have a currently active group mode setting further comprises: displaying on the communication devices and identity of an intended recipient of the incoming call.

9. The method of claim 1, further comprising: receiving the configuration parameters from an application running on each of the cells phones.

10. The method of claim 1, further comprising a method of call handling in a first home phone group comprising a first user of a first communication device and a second user of a second communication device, wherein the incoming call is routed to both first communication device and the second communication device, and answered on the first communication device by the second user, the method comprising:
providing an option on the second communication device that enables the first user to join second user on the incoming call.

11. The method of claim 10, further comprising: responsive to receiving a subsequent call for the second user while the second user is still on the incoming call using the first communication device, routing the call to the first communication device.

12. The method of claim 10, further comprising: responsive to receiving a subsequent call for the first user while the second user is still on the incoming call using the first communication device, routing the call to the second communication device.

13. The method of claim 10, further comprising: providing both the first communication device and the second communication device with an option to transfer a received call to one of a communication device that owns a phone number corresponding to the received call.

14. The method of claim 1, wherein the configuration parameters further establish routing rules for SMS messages, the routing rules comprising at least two of:
if SMS message routing is set to be delivered to a same communication device as the incoming call, and the communication device is owned by an intended message recipient, deliver the message normally to that communication device;
if the SMS message routing is set to be delivered to the same communication device as a corresponding phone call, and the communication device is not owned by the intended message recipient, deliver the message in a container that requires a user of the communication device to enter a passcode to unlock the SMS message; and
if the SMS message routing is set to be delivered to a home phone group phone number, deliver the message to one of all communication devices having active group mode settings, and to all communication devices in the home phone group regardless of group mode setting

15. An executable software product stored on a computer-readable medium containing program instructions for creating one or more home phone groups from a network of communication devices, the program instructions for:
reading configuration parameters from one or more users for the one or more home phone groups, wherein the configuration parameters for each of the one or more home phone groups include:
an assignment of communication devices to the home phone group, wherein each of the communication devices are identified by at least a corresponding phone number;
a proximity designation for each of the communication devices assigned to the home phone group that defines a proximity to a designated geographic location or to one or more other phones; and
a group mode setting for each of the communication devices assigned to the home phone group that dynamically controls participation of the corresponding communication device in the assigned home phone groups;
periodically determining a current location of each of the communication devices, and automatically activating the group mode setting for each of the communication devices when the current location of each respective communication device meets the proximity designation assigned to the communication device;
periodically receiving from at least a portion the users of the communication devices at least one of, i) a change to the designated proximity assigned to the respective communication device and ii) a manual override of the group mode setting associated with the respective communication device, to enable the users to manually control participation of their respective communication device within the home phone groups to which each respective communication device is assigned; and
responsive to receiving an incoming call to one of the communication devices, identifying which of the one or more home phone groups the communication device is assigned and automatically ringing all the communication devices on the identified home phone groups that have a currently active group mode setting.

16. The executable software product of claim 15, wherein the configuration parameters further comprise a home phone number assigned to a first home phone group.

17. The executable software product of claim 2, further comprising program instructions for: responsive to receiving a call to the home phone group number, ringing all the communication devices in the first home phone group having a currently active group mode setting.

18. The executable software product of claim 15, wherein the configuration parameters are received from by one user.

19. The executable software product of claim 15, wherein the configuration parameters are received from each user of each communication device assigned to the home phone groups.

20. The executable software product of claim 15, wherein periodically determining the current location of each of the communication devices comprises at least one of: GPS tracking, cell tower triangulation, use of network access points, and use of an IP address of an account associated with the users or the communication devices.

21. The executable software product of claim 15, wherein periodically determining the current location of each of the communication devices further comprises: automatically deactivating the group mode setting for each of the communication devices when the current location of each respective communication device is outside the proximity designation assigned to the communication device.

22. The executable software product of claim 15, wherein automatically ringing all the communication devices on the identified home phone groups that have a currently active group mode setting further comprises: displaying on the communication devices and identity of an intended recipient of the incoming call.

23. The executable software product of claim 15, further comprising program instructions for: receiving the configuration parameters from an application running on each of the cells phones.

24. The executable software product of claim 15, further comprising program instructions for a executable software product of call handling in a first home phone group comprising a first user of a first communication device and a second user of a second communication device, wherein the incoming call is routed to both first communication device and the second communication device, and answered on the first communication device by the second user, the executable software product comprising:
providing an option on the second communication device that enables the first user to join second user on the incoming call.

25. The executable software product of claim 24, further comprising program instructions for: responsive to receiving a subsequent call for the second user while the second user is still on the incoming call using the first communication device, routing the call to the first communication device.

26. The executable software product of claim 24, further comprising program instructions for: responsive to receiving a subsequent call for the first user while the second user is still on the incoming call using the first communication device, routing the call to the second communication device.

27. The executable software product of claim 24, further comprising program instructions for: providing both the first communication device and the second communication device with an option to transfer a received call to one of a communication device that owns a phone number corresponding to the received call.

28. The executable software product of claim 15, wherein the configuration parameters further establish routing rules for SMS messages, the routing rules comprising at least two of:
if SMS message routing is set to be delivered to a same communication device as the incoming call, and the communication device is owned by an intended message recipient, deliver the message normally to that communication device;
if the SMS message routing is set to be delivered to the same phone as a corresponding phone call, and the communication device is not owned by the intended message recipient, deliver the message in a container that requires a user of the communication device to enter a passcode to unlock the SMS message;
if the SMS message routing is set to be delivered to a home phone group phone number, deliver the message to one of all communication devices having active group mode settings, and to all communication devices in the home phone group regardless of group mode setting.
